(19) United States
(12) Patent Application Publication
(10) Pub. No.: US 2005/0284727 A1
(43) Pub. Date: Dec. 29, 2005

(54) Device for storage of currencies collected from vending machines

(76) Inventor: Gregory Carron, San Diego, CA (US)

Correspondence Address: DAVID B. WALLER & ASSOCIATES, 5677 OBERLIN DRIVE, SUITE 214, SAN DIEGO, CA, 92121, US

(21) Appl. No.: 11/165,764

(22) Filed: Jun. 23, 2005

Related U.S. Application Data
(60) Provisional application No. 60/583,906, filed on Jun. 29, 2004.

(51) Int. Cl. G07F 7/04

(52) U.S. Cl. 194/206

(57) ABSTRACT

A device for collecting coinage and paper currencies from a vending machine comprising a containment means formed into two compartments joined at their base, having an open end and sides. Each compartment has a securing means affixed to the open end, thereby enabling separate storage of coin and paper currencies collected from the vending machine.

### REFERENCE TO RELATED APPLICATIONS

This application is a continuation application of provisional patent application Ser. No.: 60/583,906 filed 29 Jun. 2004.

### TECHNICAL FIELD

The present invention relates to equipment used in the collection of currencies from vending machines. In particular, a device for bagging and storing coins and paper money separately.

### BACKGROUND OF THE INVENTION

In the business of vending machine operations, there is a need for individuals to periodically remove coinage and paper monies from the vending machines. Typically, the currencies are collected with a bag or pouch and taken to a secure location for separating the different coinage types and sorting the paper money types, counting and compiling.

In the collection process a single bag or pouch may be used to store both paper and coinage currencies for a machine, using additional pouches only when the one in use becomes full. When this is done, it can result in damage particularly to the paper currency.

When the currencies are counted, the coinage and paper monies must be separated, particularly if mechanical devices are used for counting the money. This process requires additional time and effort.

Therefore, there is a need in the industry for a device that provides a means to separately hold the coinage and paper currency collected from each vending machine. There also is a need to provide a security system that can be utilized to deter theft by the individuals collecting and transporting the monies.

### SUMMARY OF THE INVENTION

The present invention provides a device for collecting coinage and paper currencies from a vending machine comprising; a containment means formed into two compartments joined at their base, having open ends opposite their joined base and sides; and a securing means affixed to each open end of the two compartments, thereby enabling separate storage of coin and paper currencies collected from the vending machine or other such money collecting machines.

In one aspect of the invention the device is a reusable device and in another aspect the device is non-reusable. When the device is reusable it is preferably constructed of durable fabric. In one preferred embodiment the securing means may be a zipper and may further comprise a lock. The locking mechanism may be a loophole in the pull-tab of the zipper and a corresponding loop affixed at the end of the zipper or to the compartment. For security and accounting purposes the device may further comprise a bar code or coding.

When the device is non-reusable it may be constructed of a plastic polymer wherein the securing means is an adhesive. This configuration further comprises a removable cover sheet to protect the adhesive strip. For security and accounting purposes the device and the removable cover sheet for the adhesive strip may further comprise an identical bar code or coding.

### DESCRIPTION OF THE FIGURE

FIG. 1: Is a diagrammatic representation of one embodiment of the present invention showing (A) the front view, (B) the top view, (C) the side view, (D) another embodiment of the present invention showing the front view, (E) the top view and (F) the side view.

### DETAILED DESCRIPTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “containment means” as used herein refers to a means for providing an area for collecting and storing a number of articles, such as for example, a container, a compartment, a pouch or a bag with an open end that can be sealed to hold the articles, such as for example, coins.

The term “affixed” as used herein refers to a means for securely retaining one component of the device to another element by a variety of means known to one skilled in the art, such as, for example a zipper mechanism may be sewn or affixed by adhesive to an open end of a canvas pouch thereby providing a securing means to the pouch.

The term “securing means” as used herein refers to a means for providing a closure to a bag or a pouch such as for example, sealing an open end of a pouch with a zipper mechanism, adhesive that may be permanent or reusable, a press seal such as ZipLock™ or other similar means.

The term “locking means” as used herein refers to a means for locking a securing means of a bag or a pouch by for example, a keyed lock that is inserted in the opening on the flap of a zipper and through a corresponding opening at the closed end of the zipper or metal loop secured to the pouch.

The present invention contemplates a variety of device constructions for collecting coinage and paper currencies from a vending machine comprising, a containment means formed into two compartments joined at their base, having open ends opposite their joined base and sides, and a securing means affixed to each open end of the two compartments, thereby enabling separate storage of coin and paper currencies collected from the vending machine or other currency collecting machines.

### Containment Means

The containment means 12 may be provided in a reusable configuration or it may be designed for a one-time use. In a reusable configuration the containment means 12 may be provided with a securing means 14 that may be operated multiple times such as for example a zipper or ZipLock™. If in a non-reusable configuration the securing means 14 permanently closes the containment means 12 once engaged such as for example adhesive 16. One skilled in the art would recognize that if the device 20 is consumable, designed for a one-time use, the materials of construction should be of a cost-effective nature. Correspondingly the locking means, once activated, cannot be opened without destroying or irreparably damaging the one-time use containment means 12.

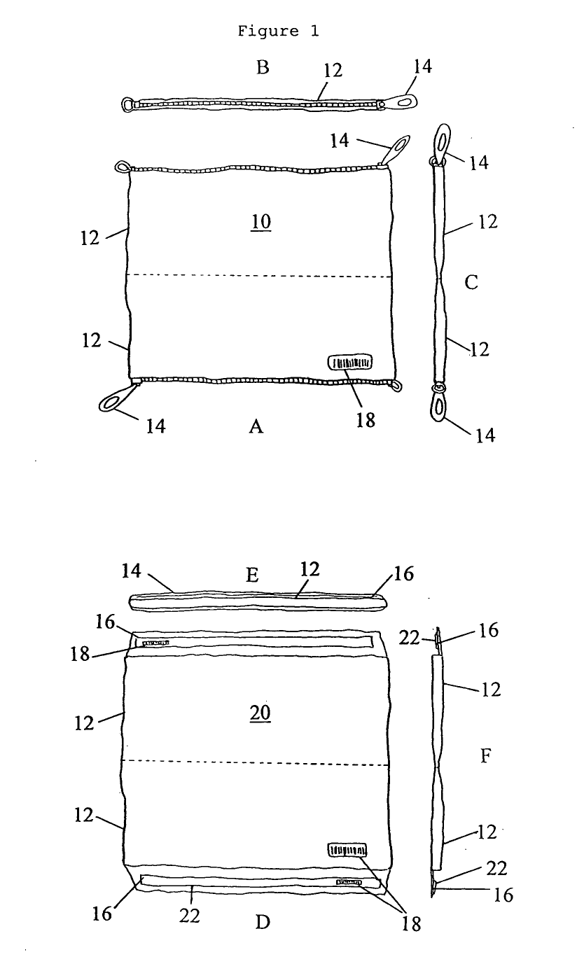

One skilled in the art would recognize that the size of the containment means 12 is dependent on the amount of coins and the amount of paper money that are generally collected from vending machines between collection periods. Preferably, the containment means 12 provides storage for currency with two compartments, one for coinage and one for paper money. Each compartment may have two panels approximately the same size and both generally rectangular in shape and affixed at three sides, thereby providing an open side for each compartment. Preferably, the two compartments are affixed to each other such that open sides of the coinage compartment and paper money compartment are on opposite ends (see FIG. 1).

Under certain circumstances a particular compartment means may require more storage volume that the other compartment means due to the particular nature of the vending machine operations and/or the type(s) of currency collected. Therefore, it may be preferable to provide one compartment means with a larger volume than the other. For example, in one configuration the coinage storage compartment means may be larger than the paper money storage compartment means.

For the collection of United States currency, the size of the interior dimensions of the paper money storage compartment means should be rectangular and have dimensions larger than the size of a currency bill or anticipated stack of currency bills. While in the United States all paper money has the same dimensions, this may not be the case in other countries. Consequently one skilled in the art would prepare, for example, a paper currency compartment means that is sufficient to hold the volume and the size of the currency of a particular country. In general, the size of the compartment means is a function of the length and width of the paper currencies, the anticipated thickness of the bills when compressed or stacked, the expansion capabilities of the compartment for anticipated volumes of coinage and a sufficient allowance for the opening for ease of insertion of the currencies. For example, when allowing for a group of U.S. currency bills that, when stacked together for a height of approximately one-inch, the size of the compartment should be at least approximately 8 inches wide and 4 inches deep. More preferably, the size should be at least 9 to 10 inches wide and 5 to 6 inches deep. In a similar way, one skilled in the art may determine the size and shape of the device 10, 20 of the present invention for other countries where the coinage and particularly the paper currencies are of different dimensions.

The containment means 12 may be constructed from a variety of materials known to one skilled in the art that provide sufficient strength, flexibility and durability to withstand the service of operation. The material should be resistant to wear encountered by coinage being dumped into the device 10 from the storage compartment in the vending machine, stacking and transport. For example, the containment means 12 may be constructed of canvas, leather, synthetic leather, reinforced fabric, plastic or any combination of these materials. Preferably, the material would be canvas for reusable storage pouches.

For containment means 12 that are designed for one-time use, the preferred material would be a heavy duty polymer plastic. The plastic should be inexpensive and may be transparent or non-transparent (opaque). For security reasons, it is preferable that it be opaque. In a non-reusable device 20 the plastic should not be so strong as to withstand an attempt to open the device 20 after the seal has been affixed. Preferably under this circumstance the device 20 becomes irreparably damaged.

One skilled in the art would recognize that there are methods that could be utilized to identify the collections from particular vending machine. For example, the use of bar codes 18 affixed to the present invention could serve as a control process identifying each individual collection. The bar codes 18 could be scanned to facilitate identification.

### Securing Means

The securing means 14 refers to a system for sealing the open side of each containment means 12 (both the coinage and paper currency compartment means). The securing means 14 may be affixed to the containment means 12 by sewing, adhesive, rivet or other method known to those skilled in the art. In one configuration the securing means 14 may allow for repeated opening and closing of the compartment means. In another configuration the securing means 14 may be permanent permitting access only by special tooling key or by cutting. Attempts to open the compartment without the correct tool or key would preferably result in irreparable damage to the device 20. The latter system provides a security system to prevent theft from personnel in the field.

One skilled in the art would recognize that the securing means 14 could be constructed of commercially available devices 10, 20 designed to provide a closure to an opening. For example, a preferred reusable securing means 14 could be a zipper mechanism affixed to the open side of the compartment means. One skilled in the art would recognize that there are a variety of similar closure devices 10, 20 available including Velcro™, snaps, ZipLocks™, resealable adhesives, and press-fit molded seams.

In one preferred embodiment the securing mechanism is non-reusable. In this embodiment the seal is preferably adhesive 16 that forms a bond of sufficient strength that any attempt to reopen the compartment would cause irreparable damage to the device 20. The thickness of the adhesive 16 strip applied to the open sides could be from not less than about ⅛ inch to not more than about 3 inches. Preferably the thickness of the adhesive strip 16 is not less than about ½ inch to not more than about 2 inches. Most preferably about ½ inch to about 1 inch.

The open sides of the device 20 may be configured to have a flap that may comprise adhesive 16 so that following collection of the currency the user may seal each compartment by merely folding the flap over the opening and adhering the flap snuggly to the opposite side of the compartment. Correspondingly the adhesive 16 may be provided on the opposite side of the compartment from the flap requiring that the user supply sufficient compression force on the currency to allow the flap to reach the adhesive 16 upon securing. Alternatively the adhesive 16 may be applied to a location distant from the opening. Upon closing the compartment the user is directed to roll the open sides together forming a preferably tight roll until reaching the adhesive strip 16, pulling the roll snuggly about the currency and then adhering the roll to the opposite side of the compartment. Correspondingly the adhesive 16 may be provided on the side receiving the rolled open end.

In another configuration more than one adhesive 16 seal is utilized. For example, the two configurations described above could be used simultaneously. The user first sealing the open ends using the flap provided and then rolling that end adhering the rolled end on to one of the sides of the compartment.

When using adhesive strips 16 it may desirable to have corresponding, or identical, bar codes 18 on the removable adhesive protection strips 22 that may be utilized with the collection recordation document as an additional method to confirm collection data.

### Assembly

Preferably, the present invention is provided in assembled form for use by the consumer. The assembly is dependent on the type of materials used in the construction. For example, if canvas is used, the containment means may be formed into a tube configuration with the open ends to serve as openings. The tube may be formed by rolling an appropriate size of material into the tube shape and affixing the ends of the material by sewing or with the use of adhesive. For separating the compartments, a straight stitch may be sewn across and about the middle of the tube between and parallel to the two open ends. If zippers are utilized to provide the securing means, they may be affixed to the open ends by sewing or by adhesive.

If the device is constructed of plastic polymer, tubular plastic sleeves of the appropriate dimension and gauge may be manufactured according to the desired specifications. The tubular plastic may be cut into desired lengths and the tube fused about its middle parallel to the open ends. The ends may be cut to provide flaps or other configuration desired for receiving the sealing means. Depending on the desired use of the plastic device a reusable or non-reusable adhesive is deposited in the desire location along the length of the open ends preferably in a strip. A removable protection sheet is applied to the adhesive to prevent the sides from adhering or being damage prior to use.

In either configuration a bar code may be applied to the device for identification, tracking and record keeping. If in a non-reusable configuration the adhesive protection cover may also have a bar code identical to the code provided on its corresponding containment means as an additional security measure for matching records with the storage device.

### Use

The device for collecting coinage and paper currencies from vending machines is designed with two separate compartments. The compartments may be the same size or one compartment may be larger than the other, depending on the typical collection practices of the particular vending machine.

For devices that are designed to be reusable, the operator would open the vending machine to gain access to the money that has been deposited in the machine. The operator would then open the storage area on the vending machine that holds the paper money and deposit the paper money into one of the compartment means of the invention for such use. The operator would seal the compartment by use of the sealing means and then flip the invention so that the coinage compartment would be on the top. The operator would then hold the invention under coin storage area and release the mechanism that drops the coinage into the coinage compartment means of the invention. The operator would then seal the coinage compartment means with the sealing means. The order in which the currency is collected is simply a matter of operator preference.

The securing means may be locked for security by use of external locks or self-locking securing means. The compartments would be therefore sealed until the time to count the currency, at which time the individual responsible for the counting operation would unlock the locking devices.

For the aspect of the invention that utilizes non-reusable compartments, the coinage and paper currencies would be collected as above and the sealing means would be activated preventing further access to the compartment means. The individual responsible for counting the currency would use a method that opens the device or may cut the device open to access the monies.

1. A device for collecting coinage and paper currencies from a vending machine comprising: a containment means formed into two compartments joined at their base, having open ends opposite their joined base and sides;
and a securing means affixed to each open end of the two compartments, thereby enabling separate storage of coin and paper currencies collected from the vending machine or other such money collection devices.

2. A device according to claim 1 wherein said device is a reusable device.

3. A device according to claim 1 wherein said device is constructed of a durable fabric.

4. A device according to claim 1 wherein the device is a non-reusable device.

5. A device according to claim 4 wherein the device is constructed of a plastic polymer.

6. A device according to claim 1 wherein said device further comprises a bar code able to be scanned for tracking and recording purposes.

7. A device according to claim 4 wherein said device further comprises a bar code.

8. A device according to claim 1 wherein said securing means is a zipper.

9. A device according to claim 1 wherein said device further comprises a lock with said securing means.

10. A device according to claim 4 wherein said securing means is an adhesive.

11. A device according to claim 11 wherein said adhesive is protected by a removable cover sheet.

12. A device according to claim 11 wherein said device and removable cover sheet have identical bar codes.
